(19) United States
(12) Patent Application Publication
(10) Pub. No.: US 2004/0100900 A1
(43) Pub. Date: May 27, 2004

(54) Message transfer system

(75) Inventors: Andrew Lines, Calabasas, CA (US); Craig Stoops, Simi Valley, CA (US); Eric Peterson, Camarillo, CA (US); Alain Gravel, Thousands Oaks, CA (US)

Correspondence Address: BEYER WEAVER & THOMAS LLP, P.O. BOX 778, BERKELEY, CA, 94704-0778, US

(73) Assignee: Fulcrum Microsystems, Inc., Calabasas, CA (US)

(21) Appl. No.: 10/452,782

(22) Filed: May 30, 2003

Related U.S. Application Data
(60) Provisional application No. 60/429,153, filed on Nov. 25, 2002.

(51) Int. Cl. H04L 1/00

(52) U.S. Cl. 370/229

(57) ABSTRACT

A message unit for transmitting messages in a data processing system characterized by an execution cycle is described. The message unit includes a message array and message transfer circuitry. The message transfer circuitry is operable to facilitate transfer of a message stored in a first portion of the message array in response to a first message transfer request. The message transfer circuitry is further operable to store up to one additional message transfer request per execution cycle while facilitating transfer of the message, and to maintain strict ordering between overlapping requests.

### RELATED APPLICATION DATA

The present application claims priority from U.S. Provisional Patent Application No. 60/429,153 entitled MESSAGE UNIT filed on Nov. 25, 2002, the entire disclosure of which is incorporated herein by reference for all purposes.

### BACKGROUND OF THE INVENTION

The present invention relates to the transmission of data in data processing systems. More specifically, the invention provides methods and apparatus for flexibly and efficiently transmitting data in such systems.

In a conventional data processing system having one or more central processing unit (CPU) cores and associated main memory, the typical data processing transaction has significant overhead relating to the storing and retrieving of data to be processed to and from the main memory. That is, before a CPU core can perform an operation using a data word or packet, the data must first be stored in memory and then retrieved by the CPU core, and then possibly rewritten to the main memory (or an intervening cache memory) before it may be used by other CPU cores. Thus, considerable latency may be introduced into a data processing system by these memory accesses.

It is therefore desirable to provide mechanisms by which data may be more efficiently transmitted in data processing systems such that the negative effects of such memory accesses are mitigated.

### SUMMARY OF THE INVENTION

According to the present invention, a message transfer system is provided which allows data to be transmitted and utilized by various resources in a data processing system without the necessity of writing the data to or retrieving the data from system memory for each transaction.

According to one embodiment, a message unit for transmitting messages in a data processing system characterized by an execution cycle is provided. The message unit includes a message array and message transfer circuitry. The message transfer circuitry is operable to facilitate transfer of a message stored in a first portion of the message array in response to a first message transfer request. The message transfer circuitry is further operable to store up to one additional message transfer request per execution cycle while facilitating transfer of the message, and to maintain strict ordering between overlapping requests.

According to another embodiment, a data processing system is provided which includes a plurality of processors, system memory, and interconnect circuitry operable to facilitate communication among the plurality of processors and the system memory. The data processing system also includes a message unit and a message array associated with each processor. The message units are operable to facilitate direct memory access transfers between the message arrays via the interconnect circuitry without accessing system memory.

According to yet another embodiment, a data transmission system is provided which includes a plurality of interfaces and interconnect circuitry operable to facilitate communication among the plurality of interfaces. A message unit and a message array are associated with each interface. The message units are operable to facilitate direct memory access transfers between the message arrays via the interconnect circuitry.

A further understanding of the nature and advantages of the present invention may be realized by reference to the remaining portions of the specification and the drawings.

### BRIEF DESCRIPTION OF THE DRAWINGS

FIG. 1 is an example of a multi-processor computing system in which various specific embodiments of the invention may be employed.

FIGS. 2-6 illustrate various flow processing configurations which may be supported in a multi-processor computing system designed according to the invention.

FIG. 7 is a block diagram illustrating a message transfer protocol according to a specific embodiment of the invention.

FIG. 8 is a block diagram of a message unit designed according to a specific embodiment of the invention.

FIG. 9 is an example of a data transmission system in which various specific embodiments of the invention may be employed.

FIG. 10 is a block diagram of a message unit designed according to another specific embodiment of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In addition, well known process operations have not been described in detail in order not to unnecessarily obscure the present invention.

Some of the embodiments described herein are designed with reference to an asynchronous design style relating to quasi-delay-insensitive asynchronous VLSI circuits. However it will be understood that many of the principles and techniques of the invention may be used in other contexts such as, for example, non-delay insensitive asynchronous VLSI as well as synchronous VLSI.

According to various specific embodiments, the asynchronous design style employed in conjunction with the invention is characterized by the latching of data in channels instead of registers. Such channels implement a FIFO (first-in-first-out) transfer of data from a sending circuit to a receiving circuit. Data wires run from the sender to the receiver, and an enable (i.e., an inverted sense of an acknowledge) wire goes backward for flow control. According to specific ones of these embodiments, a four-phase handshake between neighboring circuits (processes) implements a channel. The four phases are in order: 1) Sender waits for high enable, then sets data valid; 2) Receiver waits for valid data, then lowers enable; 3) Sender waits for low enable, then sets data neutral; and 4) Receiver waits for neutral data, then raises enable. It should be noted that the use of this handshake protocol is for illustrative purposes and that therefore the scope of the invention should not be so limited.

According to other aspects of this design style, data are encoded using 1 ofN encoding or so-called “one hot encoding.” This is a well known convention of selecting one of N+1 states with N wires. The channel is in its neutral state when all the wires are inactive. When the kth wire is active and all others are inactive, the channel is in its kth state. It is an error condition for more than one wire to be active at any given time. For example, in certain embodiments, the encoding of data is dual rail, also called 1 of2. In this encoding, 2 wires (rails) are used to represent 2 valid states and a neutral state. According to other embodiments, larger integers are encoded by more wires, as in a 1 of3 or 1 of 4 code. For much larger numbers, multiple 1 of N's may be used together with different numerical significance. For example, 32 bits can be represented by 32 1 of2 codes or 16 1 of4 codes.

In some cases, the above-mentioned asynchronous design style may employ the pseudo-code language CSP (concurrent sequential processes) to describe high-level algorithms and circuit behavior. CSP is typically used in parallel programming software projects and in delay-insensitive VLSI. Applied to hardware processes, CSP is sometimes known as CHP (for Communicating Hardware Processes). For a description of this language, please refer to “Synthesis of Asynchronous VLSI Circuits,” by A. J. Martin, DARPA Order number 6202. 1991, the entirety of which is incorporated herein by reference for all purposes.

The transformation of CSP specifications to transistor level implementations for use with various techniques described herein may be achieved according to the techniques described in “Pipelined Asynchronous Circuits” by A. M. Lines, Caltech Computer Science Technical Report CS-TR-95-21, Caltech, 1995, the entire disclosure of which is incorporated herein by reference for all purposes. However, it should be understood that any of a wide variety of asynchronous design techniques may also be used for this purpose.

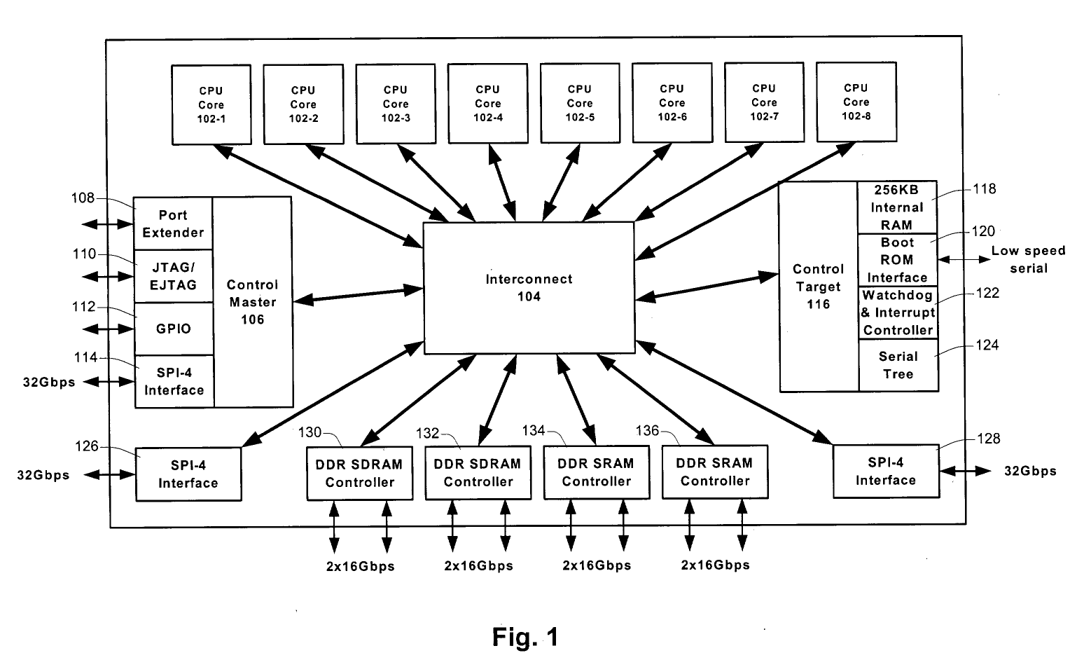

FIG. 1 is an example of a multiprocessor computing system 100 in which various specific embodiments of the invention may be employed. As discussed above, the specific details discussed herein with reference to the system of FIG. 1 are merely exemplary and should not be used to limit the scope of the invention. In addition, multiprocessor platform 100 may be employed in a wide variety of applications including, but not limited to, service provisioning platforms, packet-over-SONET, metro rings, storage area switches and gateways, multi-protocol and MPLS edge routers, Gigabit and terabit core routers, cable and wireless headend systems, integrated Web and application servers, content caches and load balancers, IP telephony gateways, etc.

The system includes eight CPU cores 102 which may, according to various embodiments, comprise any of a wide variety of processors. According to a specific embodiment, each CPU core 102 is a 1 GHz, 32-bit integer-only processor based on MIPS Technologies' MIPS32 Instruction Set Architecture (ISA) Release 2. Each processor 102 is a superset of the MIPS standard implementation, supporting instruction extensions designed to accelerate the transfer of messages between processors, as well as instruction extensions to accelerate packet processing.

Each of processors 102 is connected to the rest of the system via interconnect circuit 104. Interconnect circuit 104 interconnects all of the resources within system 100 in a modular and symmetric fashion, facilitating the transmission of data and control signals between any of the processors and the other system resources, as well as among the processors themselves. According to one embodiment, interconnect 104 is an asynchronous crossbar which can route P input channels to Q output channels in all possible combinations. According to a more specific embodiment, interconnect 104 supports 16 ports, one for each of processors 102, four for the memory controllers, two for independent packet interfaces, one for various types of I/O, and one for supporting general system control.

A specific implementation of such a crossbar circuit is described in copending U.S. patent application Ser. No. 10/136,025 for ASYNCHRONOUS CROSSBAR CIRCUIT WITH DETERMINISTIC OR ARBITRATED CONTROL (Attorney Docket No. FULCP001/#002), the disclosure of which is incorporated herein by reference in its entirety for all purposes.

Control master 106 controls a number of peripherals (not shown) and supports a plurality of peripheral interface types including a port extender interface 108, a JTAG/EJTAG interface 110, a general purpose input/output (GPIO) interface 112, and a System Packet Interface Level 4 (SPI-4) Phase 2 114. Control target 116 supports general system control (256 kB internal RAM 118, a boot ROM interface 120, a watchdog and interrupt controller 122, and a serial tree interface 124). The system also includes two independent SPI-4 interfaces 126 and 128. Two double data rate (DDR) SDRAM controllers 130 and 132, and two DDR SRAM controllers 134 and 136 enable interaction of the various system resources with system memory (not shown).

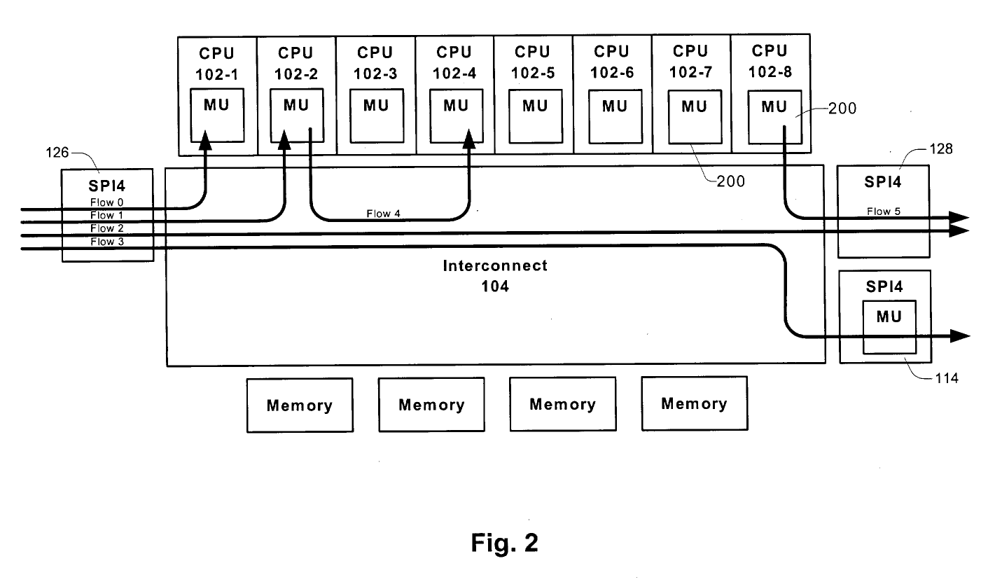

As shown in FIG. 2, each of the SPI-4 interfaces and each of processors 102 includes a message unit 200 which is operable to receive data directly from or transmit data directly to any of the channels of SPI-4 interfaces 126 and 128 and any of processors 102. For example, the message unit can facilitate a direct data transmission from a SPI-4 interface to any of processors 102 (e.g., flows 0 and 1), from on SPI-4 interface to another (e.g., flows 2 and 3), from any processor 102 to any other processor 102 (e.g., flow 4), and from any processor 102 to a SPI-4 interface (e.g., flow 5). As will be described in greater detail below, message units 200 implement a flow control mechanism to prevent overrun.

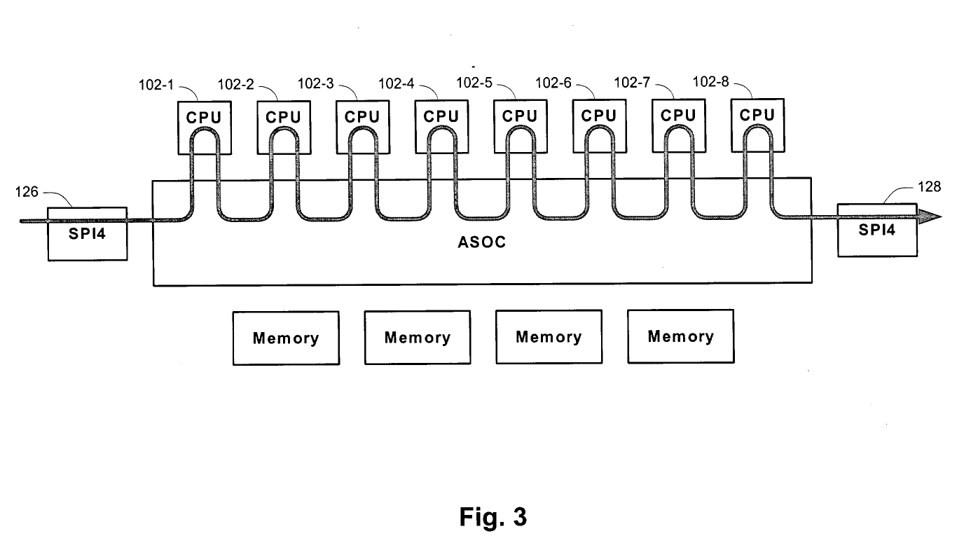

According to various embodiments, message units 200 are flexibly operable to configure processors 102 to operate as a soft pipeline, in parallel, or a combination of these two. In addition, message units 200 may configure the system to forward packet payload and header payload down separate paths. FIGS. 3 through 6 illustrate some exemplary system configurations and path topologies.

In the example illustrated in FIG. 3, processors 102 are configured so that an entire packet flow goes through all of the processors in order. In this example, none of the data packets is stored in local memory. This eliminates the overhead associated with retrieving the data from memory. Such a configuration may also be advantageous, for example, where each processor is running a unique program which is part of a more complex process. In this way, the overall process may be segmented into multiple stages, i.e., a soft pipeline.

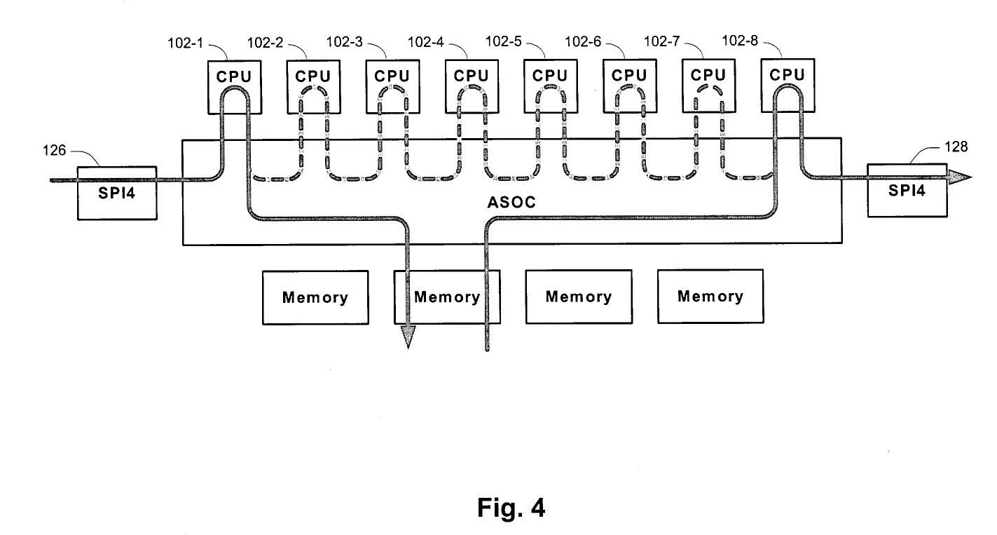

In the example shown in FIG. 4, the data portion of each packet is stored in off-chip memory by the first processor receiving the packets, while the header portion (as well as the handle) is passed through a series of processors. Such an approach is useful, for example, in a network device (e.g., a router) which makes decisions based-on header information without regard to the data content of the packet. The final processor then retrieves the data from memory before forwarding the packet to the SPI-4 interface. As in the example described above with reference to FIG. 3, each processor may be configured to run a unique program, thus allowing the header processing to be segmented into a pipeline. And eliminating the need to move the entire packet from one processor to the next in the pipeline (or retrieve the data from memory) allows a deeper processing of the header as compared to a configuration in which the header and data remain together.

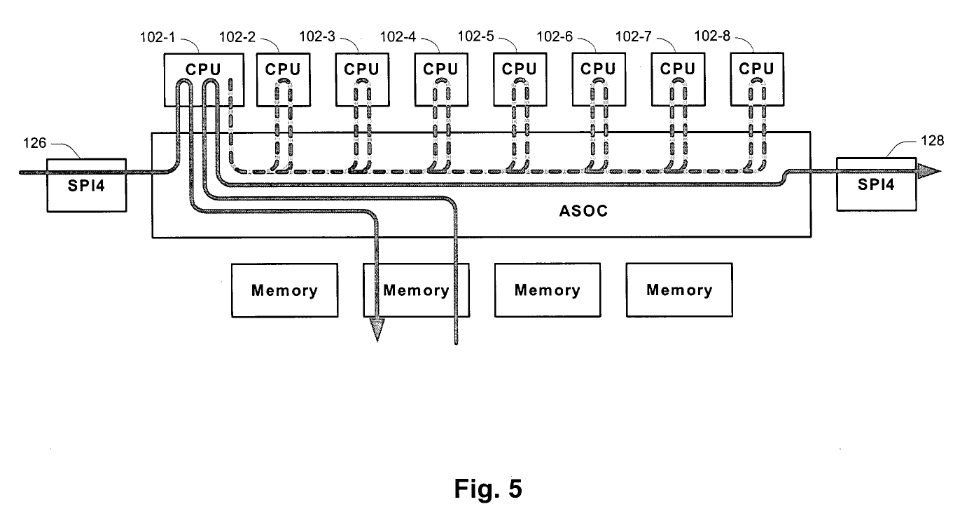

In the example shown in FIG. 5, the data portion of each packet is stored in off-chip memory as in the example of FIG. 4. However, in this case, a particular processor 102-1 maintains control of the packet and actively load balances header processing among the other processors 102. Each of the other processors 102 may be configured to run the same or different parts of the header processing. Processor 102-1 may also load balance the processing of successive packets among the other processors. Such an approach may be advantageous where, for example, processing time varies significantly from one packet to another as it avoids stalls in the pipeline, although it may result in packet reordering. It will be understood that processor 102-1 may also be configured to perform this gatekeeping/load balancing function with the entire packets, i.e., without first storing the payload in memory.

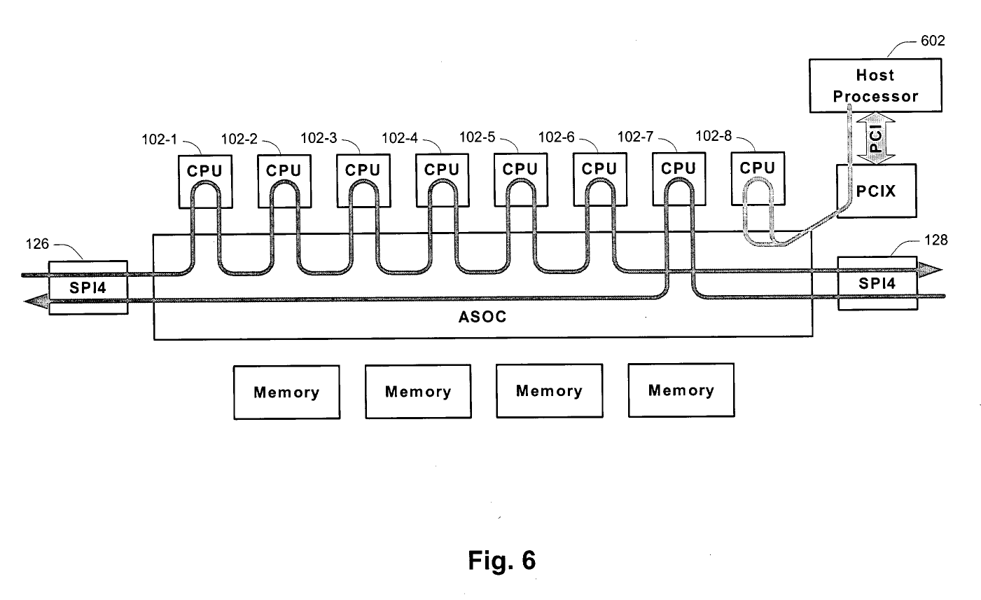

In the example shown in FIG. 6, six of the processors 102-1 through 102-6 implement pipeline processing on the ingress data path while a seventh processor 102-7 implements a lighter-weight operation on the egress data path. In this example, the eighth processor 102-8 is dedicated to internal process management and reporting. More specifically, the eighth processor is responsible for communicating with an external host processor 602 and managing the other processors using the respective message units. According to various embodiments, the number of processors associated with the ingress and egress data paths may vary considerably according to the specific applications.

According to a specific embodiment, message transfers between the various combinations of SPI-4 interfaces and processors via the interconnect are effected using SEND and SEND INTERRUPT transactions. The SEND primitive is most commonly used and is handled by the processors in their normal processing progression. The SEND INTERRUPT primitive interrupts the normal processing flow and might be used, for example, by a processor (e.g., 102-8 of FIG. 6) which is managing the operation of the other processors.

An exemplary format for these transactions (shown in Table 1) includes a 36-bit bit header followed by up to eight data words with parity. As shown, bits 32-35 associated with each 32-bit data word encodes byte parity. Bits 0 to 15 of the header indicate the address at which the data are to be stored in the message array at the destination. Bits 16 and 17 of the header encode the least significant bits of the byte length of the burst (since the burst is padded to word multiples and the last word may only have a few valid bytes). Bits 18-31 of the header are unused. Bits 32-35 of the header encode the transaction type (i.e., SEND=8, SEND INTERRUPT=9). Other transaction types relevant to the present disclosure include LOADs and STOREs which allow the processor and interfaces to read from and write to memory.

TABLE 1
SEND and SEND INTERRUPT Transactions

| | Bits 35..32 | Bits 31..18 | Bits 17..16 | Bits 15..0 |
|---|---|---|---|---|
| 1 | Transaction | Reserved | Last Word | Address |
| | Type (=8,9) | | Byte Count | |
| 2 | Parity | | Data | |
| 3 | Parity | | Data | |
| 4 | Parity | | Data | |
| 5 | Parity | | Data | |
| 6 | Parity | | Data | |
| 7 | Parity | | Data | |
| 8 | Parity | | Data | |
| 9 | Parity | | Data | |

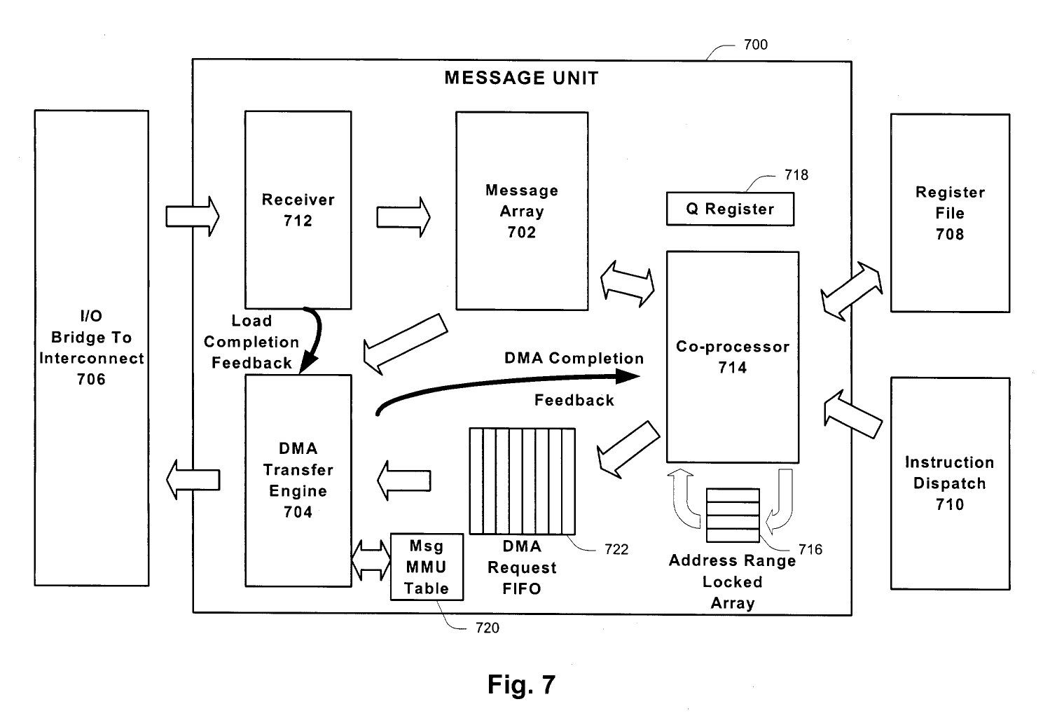

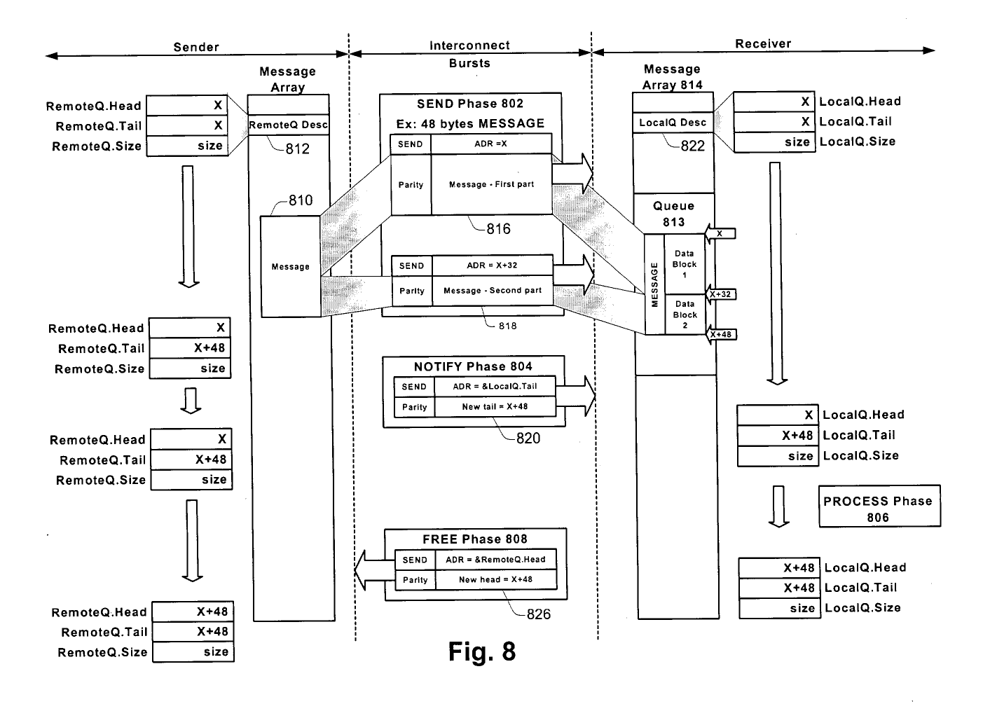

A technique for transferring a message, i.e., data, between processors using the above-described transactions in a system such as the one shown in FIG. 1 will now be described with reference to FIGS. 7 and 8. Each of the processors includes a message unit 700 as shown in FIG. 7 and as mentioned above with reference to FIG. 2. During a message transfer (illustrated in FIG. 8), one of the processors is designated the “sender” and the other the “receiver.” For each direction, both the sender and the receiver store a queue descriptor describing the receiver queue at the destination. These queues and queue descriptors are stored in each processor's message array 702 which is part of the message unit 700.

The message array in each message unit comprises one or more local message queues, a local queue descriptor for each local message queue which specifies the head, tail, and size of (i.e., contains pointers to) the local message queue, and a plurality of remote queue descriptors which contain similar pointers to each message queue in the message arrays associated with other processors. Message arrays having multiple message queues may use the queues for different types of traffic.

According to the specific embodiment of the invention illustrated in FIG. 8, a message transfer includes 4 phases: a send phase 802, a notify phase 804, a process phase 806, and a free phase 808. During the send phase, the sender sends a message 810 using SEND bursts (or SEND INTERRUPT bursts) while maintaining locally a remote queue descriptor 812 which describes the FIFO message queue 813 in the receiver's message array 814. The sender can send an arbitrary length message, fragmenting the transmission into bursts of up to 32 bytes maximum. A 48-byte message 810 resulting in two send phase bursts 816 and 818 is shown in this example. The message unit in each processor includes a DMA transfer engine 704 that effects the transfer and which performs any necessary fragmentation automatically thereby obviating the need for software to process each burst individually.

According to a specific embodiment, a packet transfer specification is employed which facilitates packet fragmentation and which accounts for the limitations of the SPI-4 interface. That is, packets are transferred between two end-points (e.g., processor to SPI-4, SPI-4 to processor and SPI-4 to SPI-4) using the message transfer protocol described herein. However, in order to reduce memory size at end-point and reduce latency, packets exceeding a programmable segment size are fragmented into smaller packet segments. Each packet segment includes a 32-bit segment header followed by a variable number of bytes and is transferred as one message which may require transmission of one or more SEND bursts. The header defines the SPI-4 channel to be used, the length (in bytes) of the segment, and whether the segment is a “start-of-packet” or “end-of-packet” segment.

As described above with reference to Table 1, each SEND burst contains the address where the data are to be stored as part of the header. This address is determined by the sender with reference to the remote queue descriptor in its message array which corresponds to the receiver. According to a specific embodiment, the sender holds transmission of the burst if the difference between the head and the tail of the remote queue (modulo to the size of the queue) is smaller than the size of the message to transmit, and may only resume transmission when the difference becomes greater than the size of the message to transmit. Once started, the whole message is sent to the receiver by the DMA engine through the intervening interconnect circuitry without interruption, i.e., the SEND bursts are transferred one after another without the sender interleaving any other burst for the same queue. According to a particular embodiment, a single SEND burst may be fragmented into two SEND bursts at queue boundaries (wrapping).

During notify phase 804, the sender notifies the receiver that a message has been fully sent to the receiver by transmitting a SEND burst (or a SEND INTERRUPT burst) 820 specifying the new tail of the remote message queue in the data portion of the burst. The header of this SEND burst contains the address of the tail pointer in the local queue descriptor 822 in the receiver's message array 824. Reception of the notify burst at the local queue descriptor 822 in the receiver causes the update of the local tail pointer in the receiver which, in turn, notifies the receiver that a message has been received and is ready for processing. That is, each processor periodically polls its local queue descriptors to determine when it has received data for processing. Thus, until the tail pointer for a particular queue is updated to reflect the transfer, the receiving processor is unaware of the data.

The next phase is process phase 806. During this phase, the receiver detects reception of the message by comparing the head and tail pointers in its local queue descriptor 822. Any difference between the two pointers indicates that a message has been fully received and also indicates the number of bytes received.

The final phase is free phase 808 in which the receiver frees the area used by transmitting a SEND burst 826 to the sender with the new head (16 bits) in the data portion of the burst. The header of this SEND burst contains the address of the head pointer in the sender's remote queue descriptor 812. That is, reception of the free phase SEND burst at the remote queue descriptor 812 in the sender causes the update of the remote head pointer.

Referring now to the specific embodiment shown in FIG. 7, a message unit 700 is shown in communication with an I/O bridge 706 which may, for example, be the interface between message unit 700 and an interconnect or crossbar circuit such as interconnection circuit 104 of FIG. 1. On the right-hand side of the diagram, message unit 700 is shown in communication with a register file 708 and an instruction dispatch 710 which are components of the processor (e.g., processors 102 of FIG. 1) of which message unit 700 may be a part.

According to an embodiment in which message unit 700 is a part of such a processor, the processor comprises a CPU core which is a MIPS32-compliant integer-only processor based on MIPS Technologies' MIPS32 Instruction Set Architecture (ISA) Release 2. According to a more specific embodiment, the CPU core is a superset of the MIPS standard implementation, supporting instruction extensions designed to accelerate the transfer of messages between processors, as well as instruction extensions to accelerate packet processing.

According to a more specific embodiment, each such CPU core operates at 1 GHz and includes an instruction cache, a data cache and an advanced dispatch instruction block that can issue up to two instructions per cycle to any combination of dual arithmetic units a multiply/divide unit, a memory unit, the branch and instruction dispatch units, the instruction cache, the data Cache, the message unit, an EJTAG interface, and an interrupt unit.

According to a specific embodiment, message unit 700 includes message array 702, DMA transfer engine 704, I/O bridge receiver 712, co-processor 714 (for executing message related instructions), address range locked array 716, Q register 718, message MMU table 720, and DMA request FIFO 722. According to one embodiment, message array 702 is 16 kB and includes local and remote queue descriptors and one or more message queues of variable size. Each local queue descriptor corresponds to one of the message queues in the same message array, and includes a field identifying the corresponding queue as a local queue, a field specifying the size of the queue, and head and tail pointers which are used as described above. The base address for the queue is embedded in the upper bits of the head pointer.

A local queue may be designated as a scratch queue and may have a corresponding descriptor indicating this as the queue type. Scratch queues are useful to store temporary information retrieved from memory or built locally by the processor before being sent to a remote device. Each remote queue descriptor corresponds to one message queue in a message array associated with another processor. This descriptor includes a field identifying the corresponding message queue as a remote queue (i.e., a message queue in a message array associated with another processor). The descriptor also includes the address of the remote queue, the size of the remote queue, and the head and tail pointers.

The queues are identified in register file 708 with 32-bit queue handles, 10 bits of which identify the queue number, i.e., the queue descriptor, and N bits of which specify the offset within the queue at which the message is located. The number of bits N specifying the offset varies depending on the size of the queue.

If the processor of which message unit 700 is a part detects a message related instruction, it dispatches the instruction (via instruction dispatch 710) to co-processor 714 which also has access to the processor's register file 708. In the case of a SEND instruction during the send phase of the message transfer protocol (described above), co-processor 714 retrieves the value from the identified register in register file 708 and posts a corresponding DMA request in DMA request FIFO 722 to be executed by DMA transfer engine 704. Because instruction dispatch 710 may dispatch SEND instructions on consecutive cycle, FIFO 722 queues up the corresponding DMA requests to decrease the likelihood of stalling. Q register 718 facilitates the execution of instructions which require a third operand.

In addition to posting the DMA request, co-processor 714 stores the address range of the part of the message array being transmitted in address range locked array 716. This prevents subsequent instructions for the same portion of the message array from altering that portion until the first instruction is completed. So, co-processor 714 will not begin execution of an instruction relating to a particular portion of a message array if it is within the address range identified in array 716. When DMA transfer engine 704 has completed a transfer, the DMA completion feedback to co-processor 714 results in clearance of the corresponding entry from array 716. I/O bridge receiver 712 receives SEND messages from remote processors or a SPI-4 interface and writes them directly into message array 702.

According to a specific embodiment, message unit 700 may also effect the reading and writing of data to system memory (e.g., via SRAM controllers 134 and 136 of FIG. 1) using LOAD and STORE instructions. Load completion feedback from receiver 712 to DMA transfer engine 704 to indicate when a load to message array 702 has been completed. A more complete summary of the instruction set associated with a particular embodiment of the invention is provided below in Tables 2-6.

TABLE 2
Message Unit Local Data Modification Instructions

| | | |
|---|---|---|
| MLW | rt, off(rs) | Load from a queue in message array. |
| MLH | | |
| MHU | | |
| MLB | | |
| MLBU | | |
| MSW | rt, off(rs) | Store into a queue in message array. |
| MSH | | |
| MSB | | |
| MLWK | rt, off(rs) | Load from the message array. Requires CP0 |
| MLHK | | privileges. |
| MLHUK | | |
| MLBK | | |
| MLBUK | | |
| MSWK | rt, off(rs) | Store into message array. Requires CP0 |
| MSHK | | privileges. |
| MSBK | | |

TABLE 3
Message Unit Data Transfer Instructions

| | | |
|---|---|---|
| MRECV | rd, rs, rt | Receive a message from a local queue. |
| MSEND | rs, rt | Send a message from a local queue to a remote |
| | | queue. |
| MLOAD | rs, rt | Load from memory into a queue in message array. |
| MSTORE | rs, rt | Store into memory from a queue in message array |

TABLE 4
Message Unit Flow Control Instructions

| | | |
|---|---|---|
| MFREE | rs | Free space by updating the head of the remote |
| | | queue in the sender with the current head of the |
| | | local queue. |
| MFREEUPTO | rs, rt | Free space by updating the head of the remote |
| | | queue in the sender with the supplied handled. |
| | | Makes MRECV's before the handle visible (and |
| | | allows sender to overwrite the queue). LQ is |
| | | given by upper bits of rs. The given Head is |
| | | wrapped properly, but is otherwise unchecked |
| | | for consistency. |
| MNOTIFY | rt | Update tail at receiver with the local value. |
| | | Makes all preceding MSEND's visible. |
| MINTERRUPT | rt | Update tail at receiver with the local value. |
| | | Makes all preceding MSEND's visible. Also |
| | | raises an interrupt on remote CPU. Requires CP0 |
| | | privileges. |

TABLE 5
Message Unit Probing Instructions

| | | |
|---|---|---|
| MWAIT | | Stall until anything arrives from the ASoC |
| | | or until interrupted. The message unit has |
| | | an activity bit set each time data has |
| | | been written in the message array. The |
| | | MWAIT instruction inspect this bit, and |
| | | if not set, wait until the bit becomes set |
| | | or until an interrupt is received. Once |
| | | the bit has been detected, the MWAIT |
| | | resets the bit before resuming execution. |
| MPROBEWAIT | rd | True if MWAIT would proceed, false if it |
| | | would stall. |
| MPROBERECV | rd, rs | Return number of full bytes in LQ to rd. |
| | | LQ is implied by upper bits of rs. |
| MPROBESEND | rd, rt | Return number of empty bytes in RO |
| | | to rd. RO is given by rt. |
| MSELECT | rt, rs, imm | Conditionally writes imm to rt if LQ |
| | | is non-empty. LQ is implied by upper bits |
| | | of rs. Can be used to quickly select a |
| | | non-empty LQ from a set of possible |
| | | channels. |

TABLE 6
Message Unit Configuration Instructions

| | | |
|---|---|---|
| MSETQ | rs, rt | Set the Q register |
| MGETQ | rt | Get the Q register |

A more specific embodiment of the message transfer protocol described above will now be described with reference to this instruction set.

According to this embodiment, to transmit a message, the sending processor first places the message into a local queue or a scratch queue. The message could be conveniently copied from memory to a scratch or local queue using the MLOAD instruction or could have been previously received from another processor or device. Once the message is in a local or scratch queue, the processor can issue a MSEND instruction to transmit a message. The MSEND instruction specifies two arguments; rs and rt. The register rs specifies the local queue number (bits 28-19) and the offset of the message in that queue (bits 15-0). The register rt specifies the remote queue number (bits 28-19) and the length of the message in bytes (bits 15-0). The remote queue descriptor defines the processor number and also contains the pointer to where the message should be stored in the message array of the destination processor. The length is arbitrary up to the size of the queue minus 4.

Before sending the message, the co-processor 714 computes the free space in the remote queue. The MSEND instruction will stall the processor if there is not enough space in the remote queue to receive the data and will resume once the head pointer is updated to a value allowing transmission to occur, i.e. when there is enough space at the destination to receive the message. Note that four empty bytes are left in the queue to avoid the queue to be fully used and create an ambiguity between empty and full queues. The remote queue tail pointer is updated once the instruction has been executed so that successive MSEND to the same destination will create a list of messages following each other.

Once all the data has been sent, the sender does an MNOTIFY to make it visible at the receiver. The NOTIFY instruction sends the new tail to the receiver allowing the receiver to detect the presence of new data.

A MPROBESEND can be used to check the amount of free space in the remote queue.

The MINTERRUPT works like an MNOTIFY but also raises a Message interrupt at the recipient processor. This is a preferred mechanism for the kernel on one processor getting the attention of the kernel on another processor.

To receive a message, the receiver does MRECV to get a handle to the head of queue and wait for enough bytes in the queue. Readiness can be tested with MPROBERECV. Once the handle is returned, the receiver can read and write the contents of that message with MLW/MSW. Finally, when the receiver is finished with the message, it does an MFREE to advance the head of the queue, both locally and remotely. Calling MRECV multiple times without MFREE in between will advance the local head but not the remote head.

Partial frees can be done with MFREEUPTO, which frees all previous MRECV memory up the specified handle.

The message unit also acts as a decoupled DMA engine for the processors. The MLOAD and MSTORE commands can move large blocks of data to and from external memories in the background. Both are referenced with respect to a local queue and the Q register. According to a specific embodiment, MLOAD only works on a scratch queue, not a local queue (to avoid incoming messages and incoming load completions from overwriting each other). The Size of the message queue is used to make the block data transfer transparently wrap at the specified power of 2 boundary. The primary application of this feature is to allow random rotation of small packets within larger allocation chunks to statistically load balance several DRAM chips and banks.

The message unit is designed to support multiple receiving queues. The process by which a message queue is selected is implementation dependent and is non-deterministic but several instructions are available to speedup the process. In order to select, the program probes each of the receiving queues using MPROBERECV or MSELECT. If none of the queues are full, the program executes an MWAIT and tries again. The MWAIT stalls until woken up by some external event, so its only purpose is to eliminate busy waiting. A sample selection in C would look like:

while(1) {

| | |
|---|---|
| if | (messageProbeReceive(LQ0)>=4) {handleQueue0( ); break;} |

else if (messageProbeReceive(LQ1)>=4) {handleQueue1( ); break;}
MessageWait( );

}

If either one of the queues has at least 4 bytes, this statement will handle one queue then continue. If both are empty, it executes the MWAIT, which will probably proceed the first time, since most likely many things have arrived since the last MWAIT. But if the queues are still both empty on the second pass, the MWAIT will suspend until something arrives. Each time something new arrives in the message array, this loop wakes up and reevaluates. In this case, the queues are handled with strict priority.

A fair round-robin selection within an infinite loop can be implemented as:

while(1) {

if (messageProbeReceive(LQ0)>=4) handleQueue0( );
if (messageProbeReceive(LQ1)>=4) handleQueue1( );
MessageWait( );

}

This ensures fairness because every time one queue wins, the other gets the next chance. In this case, the MWAIT keeps falling through as long as data keeps arriving. Only when both queues remain empty will this stall.

The MSELECT instruction can enable faster selection when the number of queue is large and when most queues are usually empties. For example:

winner=−1;
while(1) {

messageSelect(winner, 1q[3], 3);
messageSelect(winner, 1q[2], 2);
messageSelect(winner, 1q[1], 1);
messageSelect(winner, 1q[0], 0);
if (winner>=0) break;
messageWait( );

}

This does strict arbitration favoring lower indices. It compiles to 2 instructions per channel without branches or unnecessary data dependencies. Round robin arbitration can also be done by rotating the starting index to prefer the next channel after the last winner.

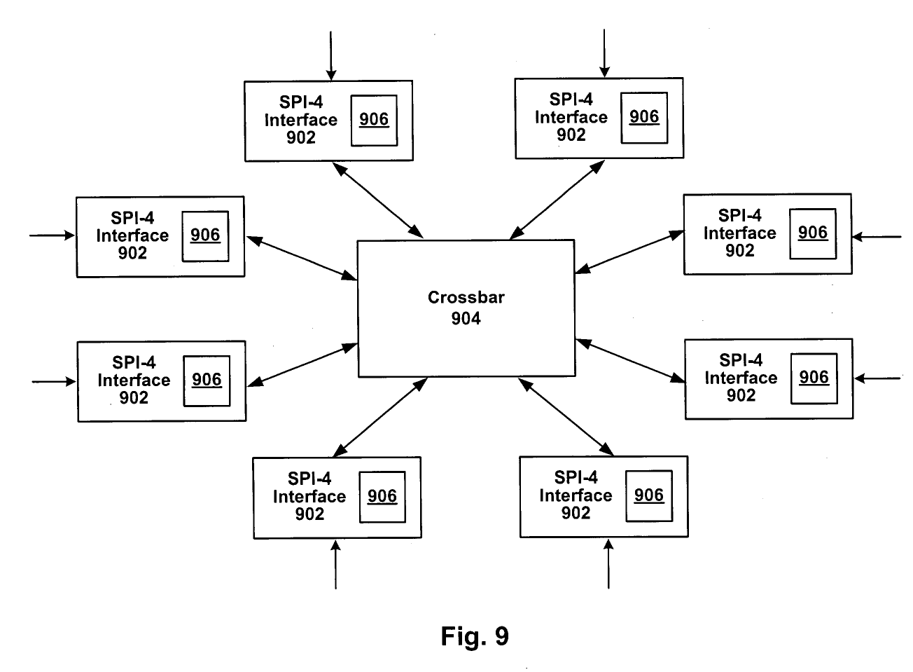

According to another embodiment of the invention, the message unit of the present invention may be employed to facilitate the transfer of data among a plurality of interfaces connected via a multi-ported interconnect circuit. An example of such an embodiment is shown in FIG. 9 in which a plurality of SPI-4 interfaces 902 are interconnected via an asynchronous crossbar circuit 904. Message units 906 are associated with each interface 902 and may be integrated therewith. This combination of SPI-4 interface and the message unit of the invention may be used with the embodiments of FIGS. 1-6 to implement the functionalities described above.

According to various embodiments, message units 906 may employ the message transfer protocols described herein to communicate directly with each other via crossbar 904. According to a specific embodiment, message units 906 are simpler than the embodiment described above with reference to FIG. 8 in that the physical location and queue size are fixed.

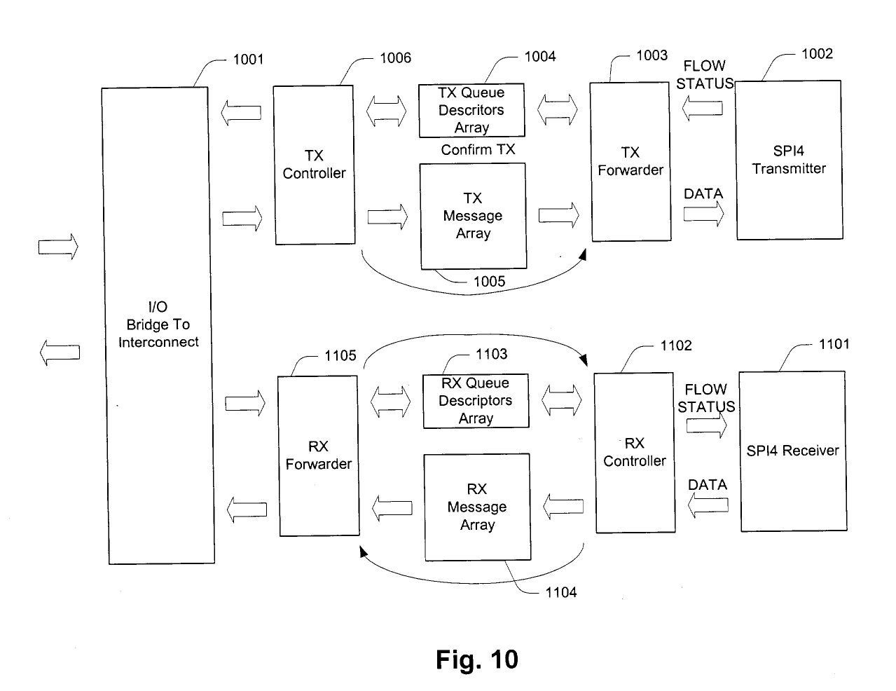

FIG. 10 is a more detailed block diagram of a message unit for use with the embodiment of FIG. 9. The incoming data are received in a data burst of up to 16 bytes by the SPI4 receiver 1101 which forwards the data burst to the RX Controller 1102. The data burst includes also a flow identifier and a data burst type to indicate if this burst is a beginning-of-packet, a middle-of-packet or an end-of-packet. The RX Controller 1102 accepts the data burst, determines the queue to use by matching the flow id to a queue number and retrieves a local queue descriptor from the RX Queue Descriptor Array 1103. The queue descriptor includes a head pointer to the message array 1104, a tail pointer in the same array, a maximum segment size and a current segment size. The RX Controller 1102 then computes the space available in the receive queue and compares to the size of the data burst received. If the data burst fits in the incoming queue, then the RX Controller 1102 stores the payload into the message array 1104 at the tail of the queue, otherwise, the data are discarded.

If the data were effectively stored, the RX Controller 1102 increments the current segment size by the size of the data burst payload and compares the current segment size accumulated to the programmed maximum segment size, and also checks if the segment is and end-of-packet. If either one of the two conditions is true, then the RX Controller 1102 prepends a segment header at the beginning of the segment using the tail pointer, increments the tail pointer by the size of the segment, resets the current segment size to 0 for the next segment, forwards an indication to the RX Forwarder 1105 that data are available on that queue, computes the space left in the queue, compares this computed value to two predefined thresholds, stores the results in a status register (2 bits per flow) and forwards the contents of the status register to the SPI-4 receiver 1101. The status register indicates the status of the queue: starving, hungry or satisfied.

The RX Forwarder 1105 maintains a list of the active flows and uses a round-robin prioritization scheme to provide fair access to the interconnect system. The RX Forwarder 1105 will retrieve a local queue descriptor and remote queue descriptor from the queue descriptor array 1103 for each active flow in the list. For each flow, the RX Forwarder 1105 checks if there is a segment to send by comparing the local queue head and tail pointers, and, if there is a segment, retrieves the segment header from the message array at the location pointed to by the head pointer to determine the size of the segment to send and then checks if the remote (another SPI4 interface or CPU connected to the same interconnect) has enough room to receive this segment.

If there is enough room at the remote to send the segment, then the RX Forwarder 1105 forwards the segment in chunks of 32 bytes to the remote using SEND messages with successive addresses derived from the remote tail pointer. Once the message has been sent, the RX Forwarder 1105 updates the head pointer of the local queue and the tail pointer of the remote queue to point to the next segment and forwards a SEND message to write the new remote tail pointer to the associated remote. If the RX Forwarder 1105 cannot send any segment for any reason, either because the remote does not have enough room to receive the segment or because there are no segments available for transmission, then the RX Forwarder 1105 removes this flow from the active flow list.

The I/O Bridge 1001 forwards the data coming from the RX Forwarder 1105 or the TX Controller 1006 to the interconnect (not shown) and also receives messages from the interconnect routing them to the RX Forwarder 1105 or the TX Controller 1006 depending on the address used in the SEND message. If the message is for the RX Forwarder 1105, then the RX Forwarder 1105 validates the address received, which could only be one of the local tail pointers, writes the new value into the queue descriptor array, reactivates the flow associated with this queue and sends an indication to the RX Controller 1102 that the queue descriptor has been updated. Upon reception of the queue descriptor update from the RX Forwarder 1105, the RX Controller 1102 recomputes the space available in the receive queue in the message array 1104 and updates the receive queue status sent to the SPI-4 receiver 1101.

If the message received from the I/O Bridge 1001 was for the TX Controller 1006, then the TX Controller 1006 will also check the address to determine if the SEND message received is a data packet or an update to a local tail pointer. If the message received is a data packet, then the data are simply saved into the message array 1005 at the address contained in the SEND message. If the message received is an update to a local tail pointer, then the new tail pointer is saved in the TX Queue Descriptors Array 1004 and an indication is sent to the TX Forwarder 1003 that there has been a pointer update for this flow, the TX Forwarder 1003 places the flow into the active flow list.

The TX Forwarder 1003 maintains three active flow lists; one for the channels that are in ‘starving’ mode, one for the channels that are in ‘hungry’ mode and one for the channels that are in ‘satisfied’ mode. Once the TX Forwarder 1003 receives an indication that a particular flow is active from the TX Controller 1006, the TX Forwarder 1003 checks the status of the channel associated with that flow and places this flow in the proper list. The TX Forwarder 1003 scans the ‘starving’ and ‘hungry’ list (starting with ‘starving’ as a higher priority list) each time either one of the lists is not empty and the SPI-4 transmitter 1002 is idle. For each flow scanned, the TX Forwarder 1003 retrieves the queue descriptor associated with this flow, checks if there are any segments to send or in the process of being sent, retrieves 16 bytes from the queue and forwards the data to the SPI-4 transmitter 1002. The queue descriptor includes a head pointer from which to retrieve the current segment, a current segment size to indicate which part of the segment has been sent, a tail pointer to indicate where the last segment terminates, and a maximum burst which defines the maximum number of successive bursts from the same channel before passing to a new channel. The queue descriptor is updated for each burst sent to the SPI4 Transmitter 1002. The TX Forwarder 1003 deletes the flow from its active list once the queue indicates that the queue is empty for that flow.

While the invention has been particularly shown and described with reference to specific embodiments thereof, it will be understood by those skilled in the art that changes in the form and details of the disclosed embodiments may be made without departing from the spirit or scope of the invention. For example, the processes and circuits described herein may be represented (without limitation) in software (object code or machine code), in varying stages of compilation, as one or more netlists, in a simulation language, in a hardware description language, by a set of semiconductor processing masks, and as partially or completely realized semiconductor devices. The various alternatives for each of the foregoing as understood by those of skill in the art are also within the scope of the invention. For example, the various types of computer-readable media, software languages (e.g., Verilog, VHDL), simulatable representations (e.g., SPICE netlist), semiconductor processes (e.g., CMOS, GaAs, SiGe, etc.), and device types (e.g., FPGAs) suitable for designing and manufacturing the processes and circuits described herein are within the scope of the invention.

Finally, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A first message unit for transmitting messages in a data processing system characterized by an execution cycle, the first message unit comprising a first message array and first message transfer circuitry, wherein the first message transfer circuitry is operable to facilitate transfer of a first message stored in a first portion of the first message array in response to a first message transfer request, the first message transfer circuitry being further operable to store up to one additional message transfer request per execution cycle while facilitating transfer of the first message, and to maintain strict ordering between overlapping requests.

2. The first message unit of claim 1 wherein the data processing system is an asynchronous data processing system and the execution cycle corresponds to an asynchronous handshake protocol.

3. The first message unit of claim 2 wherein the asynchronous handshake protocol between a first sender and a first receiver in the data processing system comprises:
the first sender sets a data signal valid when an enable signal from the first receiver goes high;
the first receiver lowers the enable signal upon receiving the valid data signal;
the first sender sets the data signal neutral upon receiving the low enable signal; and
the first receiver raises the enable signal upon receiving the neutral data signal.

4. The first message unit of claim 3 wherein the handshake protocol is delay-insensitive.

5. The first message unit of claim 1 wherein the data processing system is a synchronous data processing system and the execution cycle is determined with reference to a clock signal.

6. The first message unit of claim 1 wherein the first message array comprises a first message queue operable to store the first message, a first local queue descriptor operable to store first information relating to the first message queue, and a first remote queue descriptor operable to store second information relating to a remote message queue associated with a second message unit in the data processing system.

7. The first message unit of claim 6 wherein the first information defines available space in the first message queue, and the second information defines available space in the remote message queue.

8. The first message unit of claim 7 wherein the first message transfer circuitry is operable to send the first message to the remote queue irrespective of how the available space in the remote message queue relates to a boundary of the remote message queue.

9. The first message unit of claim 8 wherein the first message transfer circuitry is operable to fragment the first message to effect wrapping at the boundary of the remote message queue.

10. The first message unit of claim 7 wherein the first information in the first local queue descriptor comprises a first head pointer, a first tail pointer, and a first queue size for the first message queue, and the second information in the first remote queue descriptor comprises a second head pointer, a second tail pointer, and a second queue size for the remote message queue.

11. The first message unit of claim 6 wherein the first message transfer circuitry is operable to facilitate transfer of the first message to the remote message queue according to a multi-phase message transfer protocol.

12. The first message unit of claim 11 wherein the multi-phase message transfer protocol comprises sending the first message to the remote message queue, updating a second local queue descriptor associated with the remote message queue to reflect transfer of the first message, and updating the first remote queue descriptor to reflect processing of the first message at the second message unit.

13. The first message unit of claim 12 wherein the multi-phase message transfer protocol further comprises, before sending the first message, determining whether sufficient space is available in the remote message queue with reference to the first remote queue descriptor.

14. The first message unit of claim 12 wherein sending the first message comprises sending the first message in multiple message fragments where the message exceeds a first size.

15. The first message unit of claim 1 wherein the first message transfer circuitry comprises a message transfer engine for transferring the first message, and a transfer request queue for storing the first and additional message transfer requests on a first-in-first-out basis.

16. The first message unit of claim 15 wherein the first message transfer circuitry further comprises an address range locked array for storing message queue address ranges associated with the first and additional message transfer requests, the first message transfer circuitry being operable to inhibit issuance of any further message transfer requests corresponding to the address ranges.

17. The first message unit of claim 16 wherein the first message transfer circuitry further comprises a coprocessor operable to issue the first and additional message transfer requests to the transfer request queue, store the message queue address ranges in the address range locked array, inhibit issuance of the further message transfer requests, and facilitate storage of the first message in the first message array.

18. The first message unit of claim 17 wherein the coprocessor is operable to facilitate storage of the first message in the first message array by retrieving the first message from an external register file associated with the first message unit.

19. The first message unit of claim 18 wherein the coprocessor is further operable to facilitate transfer of the first message from the first message array to the external register file.

20. The first message unit of claim 1 wherein the first message transfer circuitry is operable to facilitate transfer of the first message to any of system memory associated with the data processing system, a processor associated with the data processing system, and an interface associated with the data processing system.

21. The first message unit of claim 1 wherein the first message transfer circuitry comprises a direct memory access transfer engine operable to facilitate transfer of the first message from the first message array directly to memory associated with another device in the data processing system without interacting with system memory associated with the data processing system.

22. An integrated circuit comprising the first message unit of claim 1.

23. The integrated circuit of claim 22 wherein the integrated circuit comprises any of a CMOS integrated circuit, a GaAs integrated circuit, and a SiGe integrated circuit.

24. The integrated circuit of claim 22 wherein the integrated circuit comprises a microprocessor.

25. At least one computer-readable medium having data structures stored therein representative of the first message unit of claim 1.

26. The at least one computer-readable medium of claim 25 wherein the data structures comprise a simulatable representation of the first message unit.

27. The at least one computer-readable medium of claim 26 wherein the simulatable representation comprises a netlist.

28. The at least one computer-readable medium of claim 25 wherein the data structures comprise a code description of the first message unit.

29. The at least one computer-readable medium of claim 28 wherein the code description corresponds to a hardware description language.

30. A set of semiconductor processing masks representative of at least a portion of the first message unit of claim 1.

31. A first message unit for transmitting messages in an asynchronous data processing system characterized by an execution cycle, the first message unit comprising:
a first message array comprising a first message queue, and a remote queue descriptor operable to store information relating to a remote message queue associated with a second message unit in the data processing system;
a message transfer engine operable to facilitate a direct memory access transfer of a first message stored in a first portion of the first message queue to the remote message queue in response to a first message transfer request;
a transfer request queue operable to store up to one additional message transfer request per execution cycle while the message transfer engine is facilitating transfer of the first message, and to maintain strict ordering between overlapping requests; and
a coprocessor operable in conjunction with the message array and the message transfer engine to facilitate transfer of the first message to the remote message queue according to a multi-phase message transfer protocol comprising sending the first message to the remote message queue, updating a local queue descriptor associated with the remote message queue to reflect transfer of the first message, and updating the remote queue descriptor to reflect processing of the first message at the second message unit.

32. A method for effecting transfers of messages between message units in a data processing system characterized by an execution cycle, the method comprising:
in a first message unit comprising a first message queue, a first remote queue descriptor, and message transfer circuitry, generating a first message transfer request requesting transfer of a first message in the first message queue to a second message queue in a second message unit;
while the message transfer circuitry is facilitating transfer of the first message, generating up to one additional message transfer request per execution cycle where each additional message transfer request targets a different portion of the first message queue than the first message;
sending the first message to the remote message queue using a direct memory access transfer;
updating a local queue descriptor associated with the remote message queue to reflect transfer of the first message; and
updating the remote queue descriptor to reflect processing of the first message at the second message unit.

33. The method of claim 32 further comprising determining whether sufficient space is available in the remote message queue with reference to the remote queue descriptor.

34. The method of claim 32 wherein sending the first message comprises sending the first message in multiple message fragments where the first message exceeds a first size.

35. The method of claim 32 wherein sending the first message comprises sending the first message in multiple message fragments to effect wrapping at a boundary of the remote message queue.

37. The method of claim 32 wherein the message transfer circuitry comprises an address range locked array for storing message queue address ranges associated with the first and additional message transfer requests, the message transfer circuitry being operable to inhibit issuance of any further message transfer requests corresponding to the address ranges.

38. The method of claim 32 further comprising loading the first message into the first message queue from an external register file associated with the first message unit.

39. A data processing system, comprising a plurality of processors, system memory, and interconnect circuitry operable to facilitate communication among the plurality of processors and the system memory, the data processing system further comprising a message unit and a message array associated with each processor, the message units being operable to facilitate direct memory access transfers between the message arrays via the interconnect circuitry without accessing system memory.

40. The data processing system of claim 39 wherein the data processing system is an asynchronous data processing system characterized by an asynchronous handshake protocol.

41. The data processing system of claim 40 wherein the asynchronous handshake protocol between a first sender and a first receiver in the data processing system comprises:
the first sender sets a data signal valid when an enable signal from the first receiver goes high;
the first receiver lowers the enable signal upon receiving the valid data signal;
the first sender sets the data signal neutral upon receiving the low enable signal; and
the first receiver raises the enable signal upon receiving the neutral data signal.

42. The first message unit of claim 41 wherein the handshake protocol is delay-insensitive.

43. The data processing system of claim 39 wherein the data processing system is a synchronous data processing system employing a clock signal.

44. The data processing system of claim 39 wherein the data processing system is characterized by an execution cycle, and wherein each message unit is operable to facilitate transfer of a message stored in a first portion of the corresponding message array in response to a first message transfer request, each message unit being further operable to store up to one additional message transfer request per execution cycle while facilitating transfer of the message, and to maintain strict ordering between overlapping requests.

45. The data processing system of claim 44 wherein each message array comprises a message queue operable to store the message, a local queue descriptor operable to store first information relating to the message queue, and a plurality of remote queue descriptors each being operable to store second information relating to a corresponding one of the message queues associated with another one of the message units.

46. The data processing system of claim 45 wherein each message unit is operable to facilitate transfer of the message to another message unit according to a multi-phase message transfer protocol.

47. The data processing system of claim 46 wherein the multi-phase message transfer protocol comprises sending the message to the message queue associated with the other message unit, updating the local queue descriptor associated with the message queue in the other message unit to reflect transfer of the message, and updating the remote queue descriptor corresponding to the message queue in the other message unit to reflect processing of the message at the other message unit.

48. The data processing system of claim 47 wherein the multi-phase message transfer protocol further comprises, before sending the message, determining whether sufficient space is available in the message queue in the other message unit with reference to the corresponding remote queue descriptor.

49. The data processing system of claim 44 wherein each message unit is operable to store message queue address ranges associated with the first and additional message transfer requests, each message unit being further operable to inhibit issuance of any further message transfer requests corresponding to the address ranges.

50. The data processing system of claim 44 wherein each message unit is operable to facilitate storage of the message in the associated message array by retrieving the message from an external register file associated with the corresponding processor.

51. The data processing system of claim 50 wherein each message unit is further operable to facilitate transfer of the message from the associated message array to the external register file.

52. The data processing system of claim 39 wherein each message unit is further operable to facilitate direct memory access transfers from the associated message array the system memory.

53. The data processing system of claim 39 further comprising a plurality of interfaces operable to communicate with each other and any of the processors and system memory via the interconnect circuitry, each interface having a message unit and a message array associated therewith, each message unit being operable to facilitate direct memory access transfers between the message arrays via the interconnect circuitry without accessing system memory.

54. The data processing system of claim 53 wherein the message units operable to implement a plurality of message transfer path topologies using any combination of interface-to-processor transfer, interface-to-interface transfer, processor-to-processor transfer, and processor-to-interface transfer.

55. The data processing system of claim 54 wherein the data processing system is a packet-based system, and the message units are operable to implement a first processor pipeline in which first data packets are transferred between the message units associated with a first series of the processors.

56. The data processing system of claim 55 wherein the first processor pipeline receives the first data packets from the message unit associated with a first one of the interfaces and transmits the first data packets to the message unit associated with a second one of the interfaces.

57. The data processing system of claim 55 wherein the first data packets each comprises a header and a payload, the message unit associated with a first one of the processors in the first processor pipeline being operable to transfer the headers to a next one of the processors in the first processor pipeline and to store the payloads in the system memory, the message unit associated with a final one of the processors in the first processor pipeline being operable to retrieve the payloads from the system memory and recombine the payloads with the corresponding headers.

58. The data processing system of claim 55 wherein the message units are further operable to implement a second processor pipeline in which second data packets are transferred between the message units associated with a second series of the processors.

59. The data processing system of claim 58 wherein the first processor pipeline represents an ingress data path and the second processor pipeline represents an egress data path.

60. The data processing system of claim 59 wherein a particular one of the processors and its corresponding message unit are operable to manage the ingress and egress data paths.

61. The data processing system of claim 54 wherein the data processing system is a packet-based system, and the message unit associated with a first one of the processors is operable to distribute data packets among the message units associated with others of the processors to effect load balanced processing of the data packets.

62. The data processing system of claim 61 wherein the message unit associated with the first processor is further operable to receive the processed data packets from the message units associated with the other processors.

63. The data processing system of claim 62 wherein the data packets each comprises a header and a payload, the message unit associated with the first processors further being operable to transfer the headers to the other processors and to store the payloads in the system memory, the message unit associated with the first processor also being operable to retrieve the payloads from the system memory and recombine the payloads with the corresponding headers after processing by the other processors.

64. The data processing system of claim 53 wherein each of the interfaces comprises a serial interface.

65. The data processing system of claim 64 wherein the serial interface comprises a System Packet Interface Level 4 (SPI-4).

66. The data processing system of claim 39 wherein each of the processors comprises a 32-bit integer-only processor based on MIPS Technologies' MIPS32 Instruction Set Architecture (ISA).

67. The data processing system of claim 39 wherein the interconnect circuitry comprises an asynchronous crossbar operable to route a first number of input channels to a second number of output channels in all possible combinations.

68. The data processing system of claim 39 wherein each message unit is integrated with the associated processor.

69. At least one integrated circuit comprising the data processing system of claim 39.

70. The at least one integrated circuit of claim 69 wherein the at least one integrated circuit comprises any of a CMOS integrated circuit, a GaAs integrated circuit, and a SiGe integrated circuit.

71. At least one computer-readable medium having data structures stored therein representative of the data processing system of claim 39.

72. The at least one computer-readable medium of claim 71 wherein the data structures comprise a simulatable representation of the data processing system.

73. The at least one computer-readable medium of claim 72 wherein the simulatable representation comprises a netlist.

74. The at least one computer-readable medium of claim 71 wherein the data structures comprise a code description of the data processing system.

75. The at least one computer-readable medium of claim 74 wherein the code description corresponds to a hardware description language.

76. A set of semiconductor processing masks representative of at least a portion of the data processing system of claim 39.

77. The data processing system of claim 39 wherein the data processing system comprises any one of a service provisioning platform, a packet-over-SONET platform, a metro ring platform, a storage area switch, a storage area gateway, a multi-protocol router, an edge router, a core router, a cable headend system, a wireless headend system, an integrated web server, an application server, a content cache, a load balancer, and an IP telephony gateway.

78. A data transmission system, comprising a plurality of interfaces and interconnect circuitry operable to facilitate communication among the plurality of interfaces, the data transmission system further comprising a message unit and a message array associated with each interface, the message units being operable to facilitate direct memory access transfers between the message arrays via the interconnect circuitry.

79. The data transmission system of claim 78 wherein the interconnect circuitry comprises an asynchronous crossbar operable to route a first number of input channels to a second number of output channels in all possible combinations.

80. The data transmission system of claim 78 wherein each of the interfaces comprises a serial interface.

81. The data transmission system of claim 80 wherein the serial interface comprises a System Packet Interface Level 4 (SPI-4).

82. The data transmission system of claim 78 wherein the data transmission system is an asynchronous data transmission system characterized by an asynchronous handshake protocol.

83. The data transmission system of claim 82 wherein the asynchronous handshake protocol between a first sender and a first receiver in the data transmission system comprises:
the first sender sets a data signal valid when an enable signal from the first receiver goes high;
the first receiver lowers the enable signal upon receiving the valid data signal;
the first sender sets the data signal neutral upon receiving the low enable signal; and
the first receiver raises the enable signal upon receiving the neutral data signal.

84. The first message unit of claim 83 wherein the handshake protocol is delay-insensitive.

85. The data transmission system of claim 78 wherein the data transmission system is a synchronous data transmission system employing a clock signal.

86. The data transmission system of claim 78 wherein the data transmission system is characterized by an execution cycle, and wherein each message unit is operable to facilitate transfer of a message stored in a first portion of the corresponding message array in response to a first message transfer request, each message unit being further operable to store up to one additional message transfer request per execution cycle while facilitating transfer of the message, and to maintain strict ordering between overlapping requests.

87. The data transmission system of claim 86 wherein each message array comprises a message queue operable to store the message, a local queue descriptor operable to store first information relating to the message queue, and a plurality of remote queue descriptors each being operable to store second information relating to a corresponding one of the message queues associated with another one of the message units.

88. The data transmission system of claim 87 wherein each message unit is operable to facilitate transfer of the message to another message unit according to a multi-phase message transfer protocol.

89. The data transmission system of claim 88 wherein the multi-phase message transfer protocol comprises sending the message to the message queue associated with the other message unit, updating the local queue descriptor associated with the message queue in the other message unit to reflect transfer of the message, and updating the remote queue descriptor corresponding to the message queue in the other message unit to reflect processing of the message at the other message unit.

90. The data transmission system of claim 89 wherein the multi-phase message transfer protocol further comprises, before sending the message, determining whether sufficient space is available in the message queue in the other message unit with reference to the corresponding remote queue descriptor.
